(19) United States
(12) Patent Application Publication
(10) Pub. No.: US 2004/0043724 A1
(43) Pub. Date: Mar. 4, 2004

(54) Automated continued recording in case of program overrun

(76) Inventor: John C. Weast, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/234,484

(22) Filed: Sep. 3, 2002

(51) Int. Cl. H04H 1/00; H04H 7/00

(52) U.S. Cl. 455/3.01; 455/3.06

(57) ABSTRACT

Automated continued recording of a program includes performing analysis to determine if the program is continuing past the end of a scheduled time slot; and continuing recording of the program for a predetermined period of time when the analysis indicates the program is continuing. Analysis may include one or more of audio, visual, and out-of-band analysis techniques.

### BACKGROUND

1. Field

The present invention relates generally to television and broadcast systems and, more specifically, to controlling the recording of television programs.

2. Description

Recording of television (TV) programs using analog or digital means is widespread. Video cassette recorders (VCRs) are used by millions of people to record their favorite TV programs. Recently, devices for recording of TV programs using digital means have been introduced. These devices, also known as personal video recorders (PVRs) or digital video recorders (DVRs), store selected TV programs on a storage medium such as a computer hard drive. Various TV recording technologies include products that automatically find, schedule and record selected programs to a recording device. All of these devices, however, allow only time-driven recording. That is, the viewer (or in some cases, the recording device) typically sets the channel number, start time, and duration of the program (or end time), and the device records the program broadcast on the selected channel during the specified time period. What is to be recorded is determined by the specified starting and ending times of the programs.

One problem VCRs and PVRs have is the inability to recognize when a TV program chosen for recording has run over its allotted programming schedule slot due to time delay, inaccuracy in the schedule, unanticipated longer duration, or other reasons. The problem is particularly annoying for the regular PVR user, as it happens with a relatively high frequency for programs of all types. For example, sporting events typically go over their scheduled time slot when progress of the game is slow or the game goes into overtime. Programs that end at odd times (such as 8:35 pm, instead of 8:30 pm) may be problematic when program guides or schedules only have a granularity of a half hour. Movies or other programs delayed due to earlier live broadcasts that overran previous time slots, may then run over their allotted time. Finally, schedule inaccuracies may cause problems in the recording of programs.

Current PVRs have no satisfactory solution to deal with this problem. One recording device commercially available from TiVo offers the ability to tell the recorder to stop recording a given program some set amount of time after the schedule says that it completes. This method also has problems. Referring to one of the examples above, if the user had set the PVR to record an extra half hour for a particular sporting event, there is no guarantee that the PVR will actually record the end of the game. What if the game takes 45 minutes past the scheduled time to complete? If the user sets the PVR to record every program an hour (or more) longer than the scheduled time, the user is making inefficient use of the limited recording space in the PVR, likely resulting in the erasure or cancellation of other programs. From a user's perspective, what is needed is a method for a recording device to be intelligent about the program it is recording, rather than relying solely on a predetermined programming guide or schedule.

### BRIEF DESCRIPTION OF THE DRAWINGS

The features and advantages of the present invention will become apparent from the following detailed description of the present invention in which:

FIG. 1 is a diagram of a system environment for recording programs according to an embodiment of the present invention; and

FIG. 2 is a flow diagram for recording programs according to an embodiment of the present invention.

### DETAILED DESCRIPTION

Embodiments of the present invention comprise methods that allow the automated continued recording of a broadcast program in case of the program overrunning the time slot scheduled for the program. The present invention performs analysis on the program as the program is being broadcast to determine if the program is actually continuing past its scheduled time slot. If so, the present invention directs the continued recording of the program until it determines that the program has in fact ended.

Current methods to extend the length of recording a program are manual and require technical user intervention to control a recording device such as a PVR to do something unnatural: record a program past its designated end time. These methods not only are an inconvenience to the user, but are also inaccurate. The user has no way of knowing in advance of the program airing exactly how long the program will last (this is especially true for sporting events and awards shows). Even if the user tries to manually compensate for the possibility that the program will run over, there is no guarantee that the user will be successful. Furthermore, the user may end up wasting precious space on their PVR when specifying that every program should be recorded much longer than it needs to.

In contrast, the present invention provides a recording device, such as a PVR, with the capability to make smart, automatic, dynamic run-time decisions on behalf of the user (without any required user intervention) to make the most efficient use of PVR resources, while providing maximum user convenience and satisfaction.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

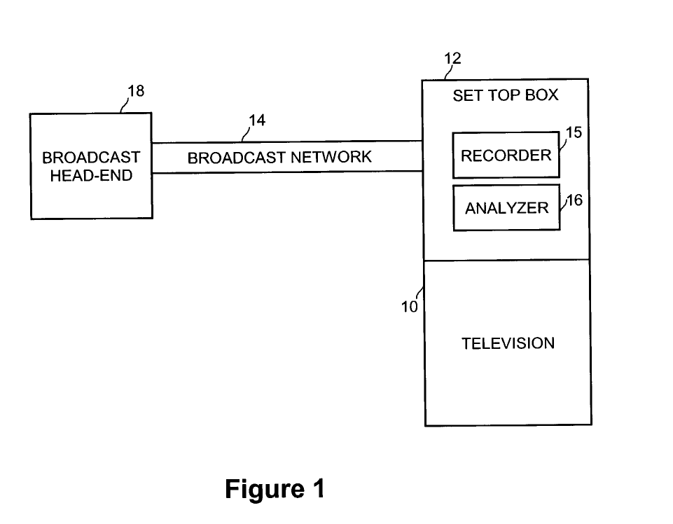

FIG. 1 is a diagram of a system environment for recording programs according to an embodiment of the present invention. A television (TV) 10 may be coupled to a set top box 12 for receiving analog or digital TV (DTV) broadcasts via a broadcast network 14. In one embodiment using a digital source for the programs, the programs may be unicast to a selected receiver. The set top box may be configured to receive analog or digital broadcast TV signals via a broadcast network comprising an antenna, cable, satellite dish, a computer network (such as the Internet for example), or any other suitable transmission mechanism. Broadcast head-end 18 broadcasts the TV signal to the set top box 12 over the broadcast network 14 using well-known methods.

In one embodiment, set top box 12 may also comprise recorder 15. Recorder 15 comprises a device or function for the recording, via either analog or digital means, of TV programs received by the set top box. Recorder 17 may be embodied in software, hardware, or any combination of the two. Recording of TV programs by recorder may be accomplished by conventional, well-known techniques. Set top box 12 determines, as a result of viewer interaction and/or electronic programming guides (EPGs), which programs and program segments to record. The set top box may accordingly control the operation of the recorder in recording programs. In some embodiments, the set top box may be integral with the TV 10 or other associated consumer electronics or computer products. In some embodiments, the recorder may be integral with the TV, the set top box, or other consumer electronics devices communicatively coupled to the set top box. In various embodiments, the recorder may be a PVR or a VCR. Set top box 12 may also comprise analyzer 16. Analyzer 16 provides analysis of programs as they are being received as described further below. Analyzer 16 may be embodied in software, hardware, or any combination of the two. The analyzer may, in various embodiments, be integral with the set top box, the recorder, the TV, or other consumer electronics devices.

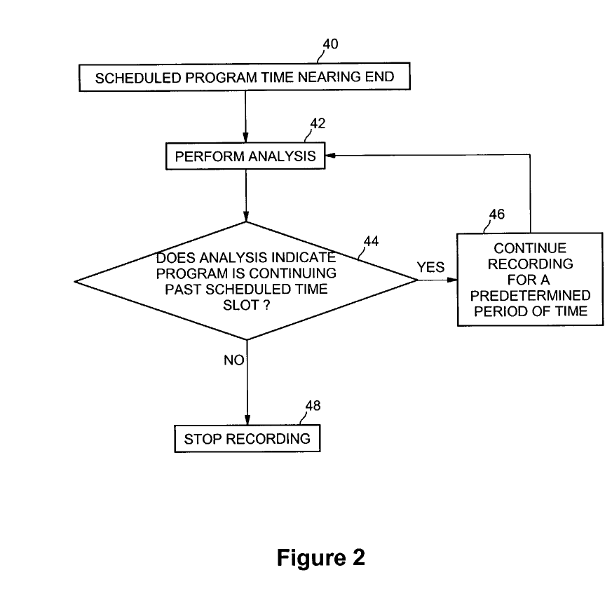

FIG. 2 is a flow diagram for recording programs according to an embodiment of the present invention. At block 40, the recorder determines that the scheduled program time is nearing the end of the scheduled time slot. The amount of time prior to the end of the time slot when block 40 is performed may be implementation dependent. For example, in various embodiments, the time may be one minute, two minutes, five minutes, ten minutes, and so on. At block 42, the analyzer automatically performs analysis of the broadcast program being received to determine if the program is continuing past the scheduled time slot. This analysis may commence at a predetermined time prior to the end of the time slot and continue until the analyzer determines that the program has ended or until a predetermined time has elapsed after the end of the scheduled time slot. In embodiments of the present invention, the recorder does not automatically stop recording the program at the end of the time slot. Instead, the recorder continues to record the program until the analyzer instructs the recorder to stop recording or until a predetermined time has elapsed after the end of the scheduled time slot. If the analysis indicates at block 44 that the program is continuing past the scheduled time slot, the recorder continues to record the program for a predetermined period of time at block 46 and control passes to the analyzer at block 42 after the predetermined time period has elapsed, for further analysis of the program being received. If the analysis indicates that the program has ended, the analyzer instructs the recorder to stop recording at block 48. The time delta between invocations of the analyzer may be implementation dependent. For example, in various embodiments, the time may be one minute, two minutes, five minutes, ten minutes, 15 minutes, 30 minutes, and so on. This time may include the time that the analyzer spends processing the program.

In this way, the user never has to worry about missing the end of a big game, or the end of a movie just because the program was lengthened or delayed. Using this invention, the user makes optimal use of limited space for recording programs on a PVR or VCR, without having to fine tune recording times to hours past the scheduled time slots just to ensure that the entire program is recorded. The recorder and analyzer combine to accurately and automatically record the desired program in its entirety. The invention makes a run-time determination, without user intervention, to continue recording a program that has gone past a scheduled time slot.

Embodiments of the present invention may also be used to make an opposite determination. That is, recording of a program may be terminated when the analyzer determines that the program has ended before its scheduled time slot is over. This capability may be combined with early switching to a next channel for a next program to allow the start of the next program to be recognized, in case the network started the broadcast early, or the user's clock was inaccurate.

There are at least three different types of analysis that may be used in the analyzer 16 to accurately determine when a program ends: audio analysis, visual analysis, and out-of-band signaling. Any combination of one or more of these types may be implemented in a given embodiment of the present invention.

By analyzing the audio component of a program, the analyzer may determine the end of the program. The analyzer may take samples of the audio component over time and compare the samples. When the samples are sufficiently different over time, the analyzer may infer that the program has ended and a different program has begun. For example, for sporting events in particular, throughout the duration of the entire broadcast of a sporting event there are usually no more than two or three different voices (e.g., commentators). The analyzer may perform one or more of known voice recognition, voice pattern, and audio analysis techniques to determine if similar audio patterns (caused by the same commentator voices) are continuing past the scheduled end of the program. If so, this is an indication that the program is running past its scheduled time slot. Generally, if the same two or three voices are detected, the same program is probably still being broadcast. When the voices are no longer detected in the samples over time, the program is probably over. In the case of a movie or a series such as a sitcom, the voices of a relatively small number of actors may predominate, and may also be detected. Any one or more of many different audio analysis algorithms may be used (e.g., “Sound Spotting—A Frame Based Approach”, by C. Spevak and R. Polfreman, of the University of Hertfordshire, United Kingdom, Proceedings of the Second Annual International Symposium on Music Information Retrieval, ISMIR 2001, pp. 35-36).

In one embodiment, the volume level of the audio component of the program may be monitored to aid in detecting the end of the program. Typically, when commercials are shown, the audio volume is raised, and when a series of commercials are shown, this may be an indication that the program is over and a new program will begin. In addition, different volume levels between programs may be detected. For example, the volume level of a sporting event program may be different than a news program or a soap opera. When used in conjunction with the voice pattern analysis, a better indication of program end may be determined.

In another embodiment, the audio pattern of the background noise in the program may be detected. For example, in a sporting event such as a basketball game or a football game, an audio pattern of the noise of the crowd may be detected in the audio component of the program and filtered out from the commentator's voices using known signal processing techniques. When the crowd noise is no longer detected, this may be an indication that the program has ended.

In any of the scenarios described above, commercials may be filtered out from the above analysis in order to more accurately detect the end of the program and to not indicate the end of the program when it isn't over yet (i.e., a false positive). Commercials may be detected via any one or more of several known methods, including taking into account the length of the commercial (e.g., 15 seconds, 30 seconds, etc.), blacking of the screen briefly before and after the commercial, the volume level, and so on. In one embodiment, the present invention could be used to determine when a commercial occurs in the broadcast by continuously performing the analysis on very small samples.

By analyzing the visual or video component of a program, the analyzer may also determine the end of the program. The analyzer may take samples of the video component over time (e.g., screen dumps, video frame samples) and compare the samples. These samples may be selected video frames of the program. When the samples are sufficiently different over time, the analyzer may infer that the program has ended and a different program has begun. Alternatively, when the samples are substantially similar, it may be inferred that the program is continuing. Many programs have very common, and often static, visual components that exist for significant spans of the program. For example, game shows (such as “Who Wants To Be A Millionaire”) use similar on-screen graphics for the length of the program that may be recognized by the analyzer using known pattern recognition techniques (e.g., see “A Survey of Image Registration Techniques” by Lisa Gottesfeld Brown, Association of Computing Machinery (ACM) Computing Surveys, Vol. 24, No. 4, December 1992). The broadcast of sporting events also exhibits this common trait. For example, basketball, baseball, and football all have on-screen scoreboards that are typically on-screen for most, if not all, of the game. Recognition of these onscreen components past the scheduled end of the program may be an indication that the recording device should continue to record as long as these visual components remain on the screen.

Various known pattern matching techniques may be used to analyze the video frames of a program. In various embodiments, detection and identification of one or more of many different visual components may be used to indicate the continuation of a program. For example, the clock in many sporting events is usually shown on the screen, often in the same location (e.g., lower right hand corner). As noted above, scoreboards are another static visual component. Text may be detected on the screen, either in the scoreboard or in the actual image. In some cases, by analyzing the text using known optical character recognition (OCR) techniques, the names of the teams may be identified from abbreviations (e.g., “LAL” for Los Angeles Lakers). Similarly, team logos may be detected through pattern matching. When the same text or logo remains in the video component, it may an indication that the program is continuing.

Visual recognition processing may be simplified or shortened taking into account knowledge about typical placement of on-screen indicators such as scoreboards in certain regions of the screen (e.g., the scoreboard on a particular TV network's sports events are always in a narrow boarder at the top of the video frame, etc.). Thus, processing for identifying screen elements may be limited to a subset of a video frame. In one embodiment, detection of the numerals of a digital clock may be used to identify when the game clock is counting down (“00:02”, “00:01”, “00:00”), which may be another indication that the program is about to end.

In another embodiment, detection of colors in the video frames may assist in identifying continuation of the program. For example, many sports are played on grass fields or have courts of a particular color (e.g., soccer, golf, tennis, baseball, and football with green backgrounds, ice hockey with a white background, basketball with a light brown background, and so on). When an identified color is still on-screen as a background or underlying image, this may be an additional indication that the program has not yet ended.

In another embodiment, the visual analysis may comprise known facial recognition techniques to identify the faces of actors in the program samples (e.g., “Face Detection in Color Images” by Rien-Lien Hsu, Mohamed Abdel-Mottaleb, and Anil K. Jain, of Michigan State University, available in 2002 on the WWW at http:--www.cse.msu.edu-˜hsureinl-facloc-index_facloc.html (with all “/” characters replaced by “-” to ensure a non-working link)). When the same actors continue to be included in the samples, it is yet another indication that the program is continuing.

In another embodiment, the broadcast head-end embeds one or more additional signals into the broadcast transmission that indicates that the scheduled program is continuing past the scheduled time slot. As long as the recording device receives the signal on a periodic basis, the recorder continues recording. When the signal is no longer sent for a particular program, the recorder interprets the lack of the signal in the transmission as an indication that the program is over. The signal may be known as a program continuance marker. The marker may be included in the vertical blanking interval (VBI) of the signal stream, in the closed captioning text area according to well-known methods, or may be embedded into the video component of the program. In one embodiment, the marker may comprise a single bit, flag, special character or symbol indicating continuation of the program. In other embodiments, the marker may comprise a text string (e.g., “program continuing . . . ”). In some embodiments, the text string marker may not be displayed on the screen, but may be used only for control information signaling the extension of the program.

In other embodiments, the marker may be sent via transmission mechanisms other than the broadcast program stream (e.g., by telephone, Internet e-mail or data packet, and so on). In any of the above techniques, the analyzer detects and receives the signal or marker and determines if the program is over or not. When the signal or marker is detected, the analyzer may generate an indicator to the recorder that the program is continuing.

In another embodiment, the analyzer analyzes the text within the closed caption stream to determine the end of the program. Textual analysis of the words in the close caption stream may indicate program content such that program continuation may be inferred. For example, in a sports program, the closed caption text may indicate the names of the commentators (e.g., “Michaels: He runs it all the way back for a touchdown!”, “Madden: That's my kind of player.”). In another example, the names of the program's characters may be detected in the closed caption stream. In yet another example, terminology used in the program may be detected (e.g., sports metaphors, terms and clichés—touchdown, home run, slam-dunk, three-pointer, field goal, etc.). Textual analysis can detect these known characteristics of the program. When these text items continue to be detected, it may be inferred that the program is still continuing.

In various embodiments, any of the above audio, visual, and out-of-band analysis techniques may be combined in a heuristic for determining a probability that the program has ended or is still continuing.

The techniques described herein are not limited to any particular hardware or software configuration; they may find applicability in any computing or processing environment. The techniques may be implemented in hardware, software, or a combination of the two. The techniques may be implemented in computer programs executing on programmable machines such as set top boxes, analog or digital televisions, VCRs, PVRs, mobile or stationary computers, personal digital assistants, and similar devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each computer program may be implemented in a high level procedural or object oriented programming language to communicate with a processing system. However, computer programs may be implemented in assembly or machine language, if desired. In any case, the language may be compiled or interpreted.

Each such computer program may be stored on a storage medium or device, e.g., compact disc read only memory (CD-ROM), digital versatile disk (DVD), hard disk, magnetic disk, or similar medium or device, that is readable by a general or special purpose programmable machine for configuring and operating the machine when the storage medium or device is read by the computer to perform the procedures described herein. The system may also be considered to be implemented as a machine-readable storage medium, configured with a program, where the storage medium so configured causes a machine to operate in a specific manner. Other embodiments are within the scope of the following claims.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A method of automated continued recording of a program comprising:
performing analysis to determine if the program is continuing past the end of a scheduled time slot; and
continuing recording of the program for a predetermined period of time when the analysis indicates the program is continuing.

2. The method of claim 1, further comprising indicating stopping of recording of the program when the analysis indicates the program has ended.

3. The method of claim 1, wherein performing the analysis comprises performing voice recognition processing of an audio component of the program to identify voices in the program to generate one of an indicator that the program is continuing and an indicator that the program has ended.

4. The method of claim 1, wherein performing the analysis comprises detecting changes in volume level of an audio component of the program over time to generate one of an indicator that the program is continuing and an indicator that the program has ended.

5. The method of claim 1, wherein performing the analysis comprises detecting changes in background noise of an audio component of the program over time to generate one of an indicator that the program is continuing and an indicator that the program has ended.

6. The method of claim 1, wherein performing the analysis comprises performing visual pattern recognition on selected video frames of the program to generate one of an indicator that the program is continuing and an indicator that the program has ended.

7. The method of claim 6, wherein the visual pattern recognition comprises face recognition of actors in the program.

8. The method of claim 6, wherein the visual pattern recognition comprises identifying background images in selected video frames of the program to generate one of an indicator that the program is continuing and an indicator that the program has ended.

9. The method of claim 6, wherein the visual pattern recognition comprises identifying on-screen graphical images in selected video frames of the program to generate one of an indicator that the program is continuing and an indicator that the program has ended.

10. The method of claim 9, wherein the on-screen graphical images comprise at least one of a text string, a digital clock, a scoreboard, and a logo.

11. The method of claim 10, wherein performing visual pattern recognition is limited to a subset of a selected video frame.

12. The method of claim 6, wherein the visual pattern recognition comprises identifying a color in selected video frames of the program to generate one of an indicator that the program is continuing and an indicator that the program has ended.

13. The method of claim 1, further comprising receiving the program in a broadcast stream and wherein performing the analysis comprises detecting a marker in the broadcast stream and generating one of an indicator that the program is continuing and an indicator that the program has ended.

14. The method of claim 13, further comprising receiving the marker in a vertical blanking interval of the broadcast stream.

15. The method of claim 1, wherein performing the analysis comprises analyzing text in a closed caption portion of the broadcast stream to generate one of an indicator that the program is continuing and an indicator that the program has ended.

16. An article comprising: a storage medium having a plurality of machine accessible instructions, wherein when the instructions are executed by a processor, the instructions provide for automated continued recording of a program by performing analysis to determine if the program is continuing past the end of a scheduled time slot; and continuing recording of the program for a predetermined period of time when the analysis indicates the program is continuing.

17. The article of claim 16, further comprising instructions for indicating stopping recording of the program when the analysis indicates the program has ended.

18. The article of claim 16, wherein instructions for performing the analysis comprise instructions for performing voice recognition, processing of an audio component of the program to identify voices in the program to generate one of an indicator that the program is continuing and an indicator that the program has ended.

19. The article of claim 16, wherein instructions for performing the analysis comprise instructions for detecting changes in volume level of an audio component of the program over time to generate one of an indicator that the program is continuing and an indicator that the program has ended.

20. The article of claim 16, wherein instructions for performing the analysis comprise instructions for detecting changes in background noise of an audio component of the program over time to generate one of an indicator that the program is continuing and an indicator that the program has ended.

21. The article of claim 16, wherein instructions for performing the analysis comprise instructions for performing visual pattern recognition on selected video frames of the program to generate one of an indicator that the program is continuing and an indicator that the program has ended.

22. The article of claim 21, wherein instructions for visual pattern recognition comprise instructions for face recognition of actors in the program.

23. The article of claim 21, wherein instructions for visual pattern recognition comprise instructions for identifying background images in selected video frames of the program to generate one of an indicator that the program is continuing and an indicator that the program has ended.

24. The article of claim 21, wherein instructions for visual pattern recognition comprise instructions for identifying on-screen graphical images in selected video frames of the program to generate one of an indicator that the program is continuing and an indicator that the program has ended.

25. The article of claim 24, wherein the on-screen graphical images comprise at least one of a text string, a digital clock, a scoreboard, and a logo.

26. The article of claim 25, wherein performing visual pattern recognition is limited to a subset of a selected video frame.

27. The article of claim 21, wherein instructions for visual pattern recognition comprise instructions for identifying a color in selected video frames of the program to generate one of an indicator that the program is continuing and an indicator that the program has ended.

28. The article of claim 16, further comprising instructions for receiving the program in a broadcast stream and wherein instructions for performing the analysis comprise instructions for detecting a marker in the broadcast stream and generating one of an indicator that the program is continuing and an indicator that the program has ended.

29. The article of claim 28, further comprising instructions for receiving the marker in a vertical blanking interval of the broadcast stream.

30. The article of claim 16, wherein instructions for performing the analysis comprise instructions for analyzing text in a closed caption portion of the broadcast stream to generate one of an indicator that the program is continuing and an indicator that the program has ended.

31. An apparatus comprising:
an analyzer to perform analysis to determine if a program is continuing past the end of a scheduled time slot; and
a recorder coupled to the analyzer to continue recording the program for a predetermined period of time when the analyzer indicates the program is continuing.

32. The apparatus of claim 31, wherein the recorder stops recording the program when the analyzer indicates the program has ended.

33. The apparatus of claim 31, wherein the analyzer performs voice recognition processing of an audio component of the program to identify voices in the program to generate one of an indicator that the program is continuing and an indicator that the program has ended.

34. The apparatus of claim 31, wherein the analyzer detects changes in volume level of an audio component of the program over time to generate one of an indicator that the program is continuing and an indicator that the program has ended.

35. The apparatus of claim 31, wherein the analyzer detects changes in background noise of an audio component of the program over time to generate one of an indicator that the program is continuing and an indicator that the program has ended.

36. The apparatus of claim 31, wherein the analyzer performs visual pattern recognition on selected video frames of the program to generate one of an indicator that the program is continuing and an indicator that the program has ended.

37. The apparatus of claim 36, wherein the visual pattern recognition comprises face recognition of actors in the program.

38. The apparatus of claim 36, wherein the visual pattern recognition comprises identifying background images in selected video frames of the program to generate one of an indicator that the program is continuing and an indicator that the program has ended.

39. The apparatus of claim 36, wherein the visual pattern recognition comprises identifying on-screen graphical images in selected video frames of the program to generate one of an indicator that the program is continuing and an indicator that the program has ended.

40. The apparatus of claim 39, wherein the on-screen graphical images comprise at least one of a text string, a digital clock, a scoreboard, and a logo.

41. The apparatus of claim 40, wherein performing visual pattern recognition by the analyzer is limited to a subset of a selected video frame.

42. The apparatus of claim 36, wherein the visual pattern recognition comprises identifying a color in selected video frames of the program to generate one of an indicator that the program is continuing and an indicator that the program has ended.

43. The apparatus of claim 31, wherein the analyzer detects a marker in a broadcast stream that includes the program and generates one of an indicator that the program is continuing and an indicator that the program has ended.

44. The apparatus of claim 43, wherein the analyzer receives the marker in a vertical blanking interval of the broadcast stream.

45. The apparatus of claim 31, wherein the analyzer analyzes text in a closed caption portion of the broadcast stream to generate one of an indicator that the program is continuing and an indicator that the program has ended.
